(19) United States
(12) Patent Application Publication
(10) Pub. No.: US 2026/0119981 A1
(43) Pub. Date: Apr. 30, 2026

(54) INFORMATION PROCESSING METHOD AND DEVICE

(71) Applicant: Lenovo (Beijing) Limited, Beijing (CN)

(72) Inventors: Zongfu QU, Beijing (CN); Dong XIE, Beijing (CN); Jinyi ZOU, Beijing (CN)

(21) Appl. No.: 19/003,536

(22) Filed: Dec. 27, 2024

(30) Foreign Application Priority Data
Dec. 29, 2023 (CN) 202311869181.7

(51) Int. Cl. G06N 20/00

(52) U.S. Cl. CPC G06N 20/00

(57) ABSTRACT

An information processing method includes obtaining task information input by a user, determining a task response result corresponding to the task information based on a multi-task processing model, and outputting the task response result. The multi-task processing model is a model with quantized weight layers. The quantization methods corresponding to different weight layers are different.

### CROSS-REFERENCE TO RELATED APPLICATION

This application claims priority to Chinese Patent Application No 2023118691817 filed on December 29 2023 and the entire content of which is incorporated herein by reference

### TECHNICAL FIELD

The present disclosure relates to the field of information processing technology specifically to an information processing method a device and a storage medium

### BACKGROUND

In various scenarios, it is often necessary to determine task response results based on task information provided by users, utilizing multi-task processing models such as large language models. For example, multi-task processing models can be used to translate target information within task information, confirm responses to target information requiring processing, identify the intent of the task information, or generate control commands corresponding to the task information.

To ensure the accuracy of response predictions made by multi-task processing models with increased complexity, higher resource demands for storing and running such models is created. However, due to the limited hardware resources of smaller electronic devices, such as mobile phones, deploying large-scale multi-task processing models on these devices is not feasible. Consequently, addressing how to enable these devices to leverage multi-task processing models to predict response results for task information accurately has become a technical problem that needs to be solved by those skilled in the field.

### SUMMARY

One aspect of the present disclosure provides an information processing method. The method includes obtaining task information input by a user, determining a task response result corresponding to the task information based on a multi-task processing model, and outputting the task response result. The multi-task processing model is a model with quantized weight layers. The quantization methods corresponding to different weight layers are different.

Another aspect of the present disclosure provides an information processing device including a task acquisition unit a task processing unit and a result output module The task acquisition unit is configured to obtain task information input by a user The task processing unit is further configured to determine a task response result corresponding to the task information based on a multi-task processing model The multi-task processing model is a model with quantized weight layers and the quantization methods corresponding to different weight layers are different The result output unit is configured to output the task response result

The third aspect of the present disclosure provides an electronic device including one or more processors and one or more memories The one or more memories storing a program that when executed by the one or more processors causes the one or more processors to obtain task information input by a user determine a task response result corresponding to the task information based on a multi-task processing model and output the task response result the multi-task processing model is a model with quantized weight layers Quantization methods corresponding to different weight layers are different

### BRIEF DESCRIPTION OF THE DRAWINGS

To more clearly illustrate the technical solutions in the embodiments of the present disclosure drawings required for the description of the embodiments are briefly described below Obviously the drawings described below are merely some embodiments of the present disclosure For those skilled in the art other drawings can be obtained based on these drawings without creative efforts

FIG. 1 is a flowchart of an information processing method according to an embodiment of the present disclosure

FIG. 2 is a flowchart of obtaining a quantized multi-task processing model in an embodiment of the present disclosure

FIG. 3 is another flowchart of obtaining the quantized multi-task processing model in an embodiment of the present disclosure

FIG. 4 is a schematic framework diagram of obtaining the quantized multi-task processing model in an embodiment of the present disclosure

FIG. 5 is another flowchart of the information processing method according to an embodiment of the present disclosure

FIG. 6 is a schematic framework diagram of the de-quantization process of a weight layer under the auxiliary control of a model control module in an embodiment of the present disclosure

FIG. 7 is a schematic diagram of an information processing device according to an embodiment of the present disclosure

FIG. 8 is a schematic diagram of an electronic device according to an embodiment of the present disclosure

### DETAILED DESCRIPTION OF THE EMBODIMENTS

To enable those skilled in the art to better understand the technical solutions of the embodiments of the present disclosure, the technical solutions in the embodiments of the present disclosure will be clearly and completely described below in conjunction with the accompanying drawings. Obviously, the described embodiments are merely part of the embodiments of the present disclosure, not all of the embodiments. Based on the embodiments of the present disclosure, all other embodiments obtained by those skilled in the art without creative work are within the scope of the present disclosure.

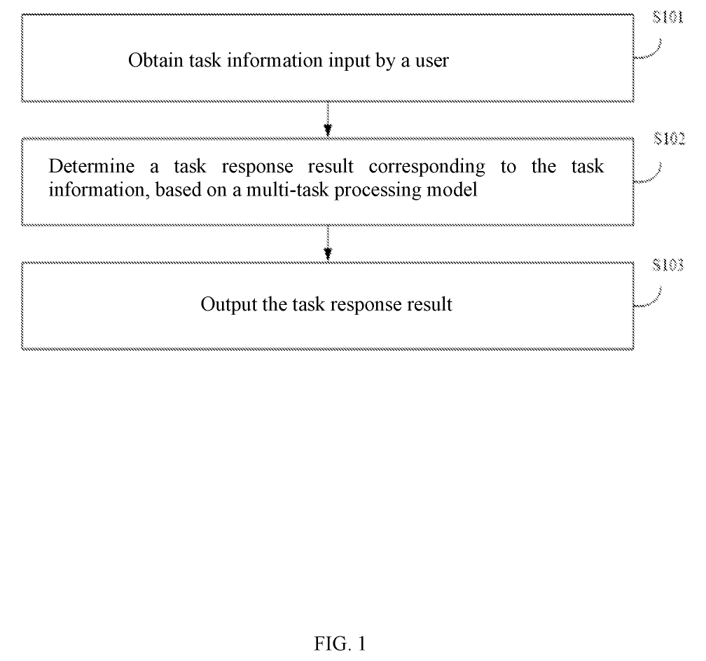

FIG. 1 is a flowchart of an information processing method provided in the present disclosure. This method can be applied to electronic devices, such as mobile phones, laptops, and desktop computers. An embodiment of the present disclosure includes the following steps:

At S101: obtaining task information input by the user.

In this case, the task information is the information used to indicate the task to be processed.

For example, the task information may include: indication information to specify the task type, and task content related to the task to be processed. In this case, the task types that may be indicated within the task information may include, but are not limited to, translation, intent recognition, conversation response, email sending, application invocation, and execution of specified operations etc. Moreover, the task content within the task information is the information that needs to be processed under the corresponding task type.

For example, the task information could be: to translate “what a happy day”. In this case, “translate” specifies the task type as translation, while “what a happy day” is the specific content that needs to be translated.

Another example of task information might be: "Why do humans need sleep?" In this case, the task type is indicated as responding to a question, and the task information itself is the content of the question that requires a response.

Another example is task information like: “Send an email to Zhang San telling him that the meeting is at 5:00 PM in the conference room.” In this case, the task information specifies the task type as sending an email and includes necessary details such as the recipient and the email content to complete the specific task of sending an email.

Obviously, the above examples are only for illustration. In practical applications, task information can be in various different forms. These details are not further elaborated here.

In the present disclosure, the task information may be in various forms. For instance, the task information may include data in the form of voice or text.

Obviously, the task information may also include other data information, such as images or videos. For example, task information can include an image along with the text “Write a poem based on this image” to facilitate following process of generating a poem that matches the image through a multi-task processing model.

At S102, determining task response result corresponding to the task information, based on a multi-task processing model.

At S103, outputting the task response result.

In the present disclosure, the multi-task processing model is deployed on an electronic device. This model can handle various types of tasks based on the different types of task information provided. For instance, the multi-task processing model may be a large language model, or any other types of task processing models, which shall not be limited.

In this case, the task response result is the response generated by the multi-task processing model after analyzing and processing the task information.

Depending on the task type and task content indicated by the task information, the task response result shall be different accordingly. As a consequence, the specific output method for the specific task response result can also be different, which shall not be limited here.

For instance, the task response result may include information about the operation actions determined by the multi-task processing model, based on the task information, and the information about the target object for executing these actions (such as an electronic device or an application layer). Additionally, the task response result could be the processed outcome that needs to feedback to the user.

Based on this, in one possible implementation, outputting the task response result may include at least one of the following options:

Outputting the task response result to an output device within the electronic device, which lets the user receive the task response result;

Outputting the task response result to a target application installed in the electronic device, which controls the target application to execute the task operation according to the task response result.

In this case, the output device may be either on or both of a display screen, and an audio output device. The choice of output device can be different depending on the type of task response result.

For instance, if the task response result includes text or images to feedback to the user, the output device can be a display screen. If the task response result includes audio information to feedback to the user, then the output device can be an audio output device. If the task response result includes a short video to feedback to the user, then the display screen needs to display the video image, and the audio output device needs to output the audio content of the video.

In this case, the target application refers to an application that needs to perform task operations based on the task response result. For example, it needs to perform operations related to the task response result under the invocation of the multi-task processing model, or to output content related to the task response result.

To help understanding, several scenarios are provided as following examples.

For example, if the task information includes content that needs to be translated, the task response result could be the translation output by the multi-task processing model. In this case, the translation result can be displayed on the screen of the electronic device or played through a speaker.

In another example, if the task information indicates the need to send an email, then the task response result may include the content of the email to be sent. In this case, outputting the task response result could involve invoking the interface of an email application, and then sending the required email content to the email application to complete the email sending operation.

Obviously, there may be other possibilities for the task response result and the output of the task response result, which are not further elaborated here.

In the present disclosure, the multi-task processing model is a model in which each weight layer has been quantized, and the quantization methods corresponding to different weight layers can be different.

In this case, the weight layer refers to a model layer (also known as a network layer) with weight coefficients.

It can be understood that, the main purpose of quantizing the model is to improve the execution efficiency of the model on hardware, and to reduce the storage and computation costs. Based on this, quantizing the weight layers may involve quantizing the data of the weight layers from floating-point data to integer data of a first bit width. Therefore, the data in each weight layer of the multi-task processing model is represented as quantized integer data of the first bit width.

For any given weight layer, using integer data of the first bit width to represent the data of this weight layer requires a smaller data size than using floating-point data. This reduces storage space, and improves the computational speed, due to using the quantized weight layers.

Depending on the multi-task processing model, the weight layers in multi-task processing model before quantization, can be represented by 32-bit floating-point data or 16-bit floating-point data, which shall not be limited here.

In the present disclosure, the multi-task processing model is a quantized model. Therefore, the data in the weight layers of this multi-task processing model are integers of a first bit width. The first bit width can be set as needed. For example, the integer data of the first bit width can be either int4 or int8. To minimize the data volume of the multi-task processing model, the integer data of the first bit width can be int4, which is using 4-bit integers to represent the data in the weight layers.

In contrast to current model quantization approaches that only apply quantization to some of the weight layers within the model, in the present disclosure, all weight layers within the multi-task processing model are quantized. This makes the multi-task processing model to have a smaller data size, and more lightweight and faster in task processing. As a result, it is feasible to deploy the multi-task processing model on user terminals and other compact electronic devices.

In contrast to current quantized models that use a single quantization method, in the present disclosure, different weight layers within the multi-task processing model can use different quantization methods, which allows for more effective quantization based on the characteristics of each weight layer.

For example, in one embodiment of the present disclosure, considering that the multi-task processing model can be divided into multiple modules in it structure, and that the weight layers within the same module shall have similar characteristics, the method provided in the presented disclosure can apply the same quantization method to the weight layers within the same modules of the multi-task processing model, while the quantization methods used for the weight layers in different modules may be different.

As can be seen from the above, in this embodiment of the present disclosure, the weight layers of the multi-task processing model have been quantized. This quantization can effectively reduce the size of the multi-task processing model, and also help to increase the speed while the model processes task information. This enables the multi-task processing model to be suitable for processing task information on compact electronic devices. Moreover, the quantization methods applied to different types of weight layers in the multi-task processing model are not entirely identical, which allows for a more effective quantization approach for each weight layer. This helps maintain data processing accuracy in the weight layers, and achieves a balance between the model size and processing accuracy. Consequently, this also enhances task information processing speed on compact electronic devices without sacrificing processing accuracy.

It is understood that the specific model structure of the multi-task processing model may be different across different application scenarios. In the present disclosure, there shall not be limitations on the model structure of the multi-task processing model.

Although diversity is preserved in the model structure of the multi-task processing model, most multi-task processing models consist of three types of modules. For example, the multi-task processing model includes: a vector encoding module, a result output module, and at least one feature processing module. The at least one feature processing module is positioned between the vector encoding module and the result output module.

The vector encoding module is used to encode the data input into the multi-task processing model.

The result output module serves as the output layer of the multi-task processing model and is used to output the processing results of the multi-task processing model.

The feature processing module is the most critical model layer in the multi-task processing model. It is responsible for performing feature processing on the encoding of the input information to identify features that characterize the task response result.

In practical applications, based on different requirements, the vector encoding module, the result output module, and the at least one feature processing module in the multi-task processing model may be different in their configurations.

For example, the vector encoding module in the multi-task processing model may be an embedding layer; the feature processing module may be a Transformer layer; and the result output module, also known as the head layer, may be different depending on the specific task, which shall not be limited here.

In the present disclosure, the weight layers within the vector encoding module, feature processing module, and result output module of the multi-task processing model can employ different types of quantization methods.

For example, in one possible implementation, the weight layers in the vector encoding module of the multi-task processing model are obtained through asymmetric quantization processing, while the weight layers in the feature processing module and result output module of the multi-task processing model are obtained through symmetric quantization processing.

In this case, asymmetric quantization refers to quantization processing using an asymmetric quantization algorithm, whereas symmetric quantization uses a symmetric quantization algorithm for processing.

It is understood that, based on the characteristics of symmetric and asymmetric quantization methods, asymmetric quantization can better preserve the model accuracy compared to symmetric quantization, but the size of the quantized model can be relatively bigger. Based on this characteristic, the method provided in the present disclosure takes into account that the vector encoding module in the multi-task processing model has a relatively small size, and because the vector encoding module is positioned at the forefront of the multi-task processing model, the accuracy of the vector encoding module output has a significant impact on the accuracy of the output results from the subsequent feature processing module and result output module.

Based on the above consideration, to reliably ensure the inference accuracy of the multi-task processing model while minimizing its size as much as possible, the method provide in the present disclosure, applies asymmetric quantization only to the weight layers in the vector encoding module of the multi-task processing model, whereas the weight layers in the feature processing module and result output module are obtained through symmetric quantization.

In the present disclosure, there may be various possible implementations to implement the quantized multi-task processing model, which shall not be limited. An example implementation is provided below to illustrate the process of obtaining the quantized multi-task processing model.

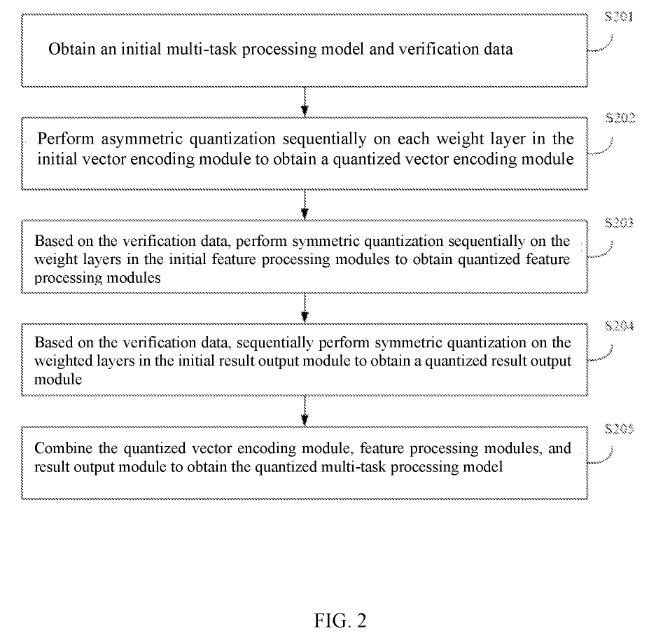

FIG. 2 is a flowchart of an embodiment of the present application, presenting the process of obtaining the quantized multi-task processing model. The process in this embodiment includes:

At S201, obtaining an initial multi-task processing model and verification data.

In this case, the initial multi-task processing model includes an initial vector encoding module, an initial result output module, and at least one initial feature processing module.

For a better differentiation, the multi-task processing model prior to quantization is referred to as the initial multi-task processing model in the present disclosure. Accordingly, the vector encoding module, the feature processing module, and the result output module in the initial multi-task processing model are referred to as the initial vector encoding module, initial feature processing module, and initial result output module, respectively.

In this case, the verification data is a dataset used for quantization calibration of the multi-task processing model.

For instance, the verification data may include multiple pairs of data samples, each pair comprising a task information sample and a task response result sample.

At S202, performing asymmetric quantization processing sequentially on each weight layer in the initial vector encoding module to obtain a quantized vector encoding module.

In this process, no quantization is performed on non-weight layers within the initial vector encoding module. The non-weight layer refers to a model layer that does not contain weight coefficients. The non-weight layers of the initial vector encoding module are the model layers other than the weight layers within the initial vector encoding module.

In the present disclosure, the quantization processing of the initial multi-task processing model may be executed on a server or other electronic device, separate from the electronic device where the multi-task processing model is deployed. A model quantization module, which may be a program module for controlling model quantization, can be deployed on the electronic device performing the quantization processing. Through this model quantization module, the weighted and non-weight layers within each module of the multi-task processing model can be decomposed. For instance, the weighted and non-weight layers in the initial vector encoding module can be decomposed. Accordingly, the model quantization module performs the corresponding quantization processing on the weight layers within each module.

In this case, the vector encoding module obtained through quantization processing includes: the weight layers in the initial vector encoding module that has been applied asymmetric quantization, and the non-weight layer in the initial vector encoding module that are not quantized.

At S203, based on the verification data, performing symmetric quantization processing sequentially on the weight layers in the initial feature processing modules, to obtain quantized feature processing modules.

It is understood that the multi-task processing model may include at least one initial feature processing module. Generally, it may include multiple initial feature processing modules. These initial feature processing modules are arranged sequentially in layers. Based on this, during the quantization process of the multi-task processing model, each initial feature processing module needs to be processed layer by layer in sequence.

Moreover, for the initial feature processing modules, at least one weight layer and at least one non-weight layer shall be configured in each initial feature processing module. Based on this, the model quantization module can be used to separate the weighted and non-weight layers within each initial feature processing module, and then apply symmetric quantization sequentially to each weight layer.

In this case, for each weighted layer in the initial feature processing module, any symmetric quantization method can be used to perform symmetric quantization processing on the weighted layer based on the verification data, which shall not be limited here.

In one embodiment of the present disclosure, to reduce the complexity of the quantization process, this application can also use the verification data to calculate the Hessian matrix H. Then, matrix decomposition of the Hessian matrix H is performed using the square root method (also known as the Cholesky Decomposition), which decomposes the Hessian matrix and obtain a lower triangular matrix. Based on this, after solving for the inverse matrix of the lower triangular matrix, symmetric quantization processing can be performed on the weight layers, based on this inverse matrix and the verification data. Compared to the Hessian matrix, the inverse matrix of the lower triangular matrix has a relatively simpler structure, which can further reduce computational complexity during the quantization process, and also reduce the complexity of the overall quantization process.

In this case, the quantized feature processing module includes the weight layers in the initial feature processing module that have been applied symmetric quantization, and the non-weight layers in the initial feature processing module that have not applied quantization.

At S204, based on the verification data, sequentially performing symmetric quantization on the weighted layers in the initial result output module, to obtain a quantized result output module.

The process of symmetric quantization on the weighted layers in the initial result output module is similar to the process applied on the weighted layers in the initial feature processing module, and specific details can be referred to in the previous descriptions, which will not be repeated here.

Accordingly, the quantized result output module includes the weighted layers in the initial result output module that have been applied symmetric quantization, as well as the non-weighted layers in the initial result output module that are not quantized.

At S205, combining the quantized vector encoding module, feature processing modules, and result output module to obtain the quantized multi-task processing model.

In this case, by combining and encapsulating the vector encoding module, feature processing modules, and result output module obtained after quantization processing, the multi-task processing model derived from quantizing the initial multi-task processing model can be obtained. This helps the deployment of the multi-task processing model on electronic devices at the user end.

It is understood that for any given weight layer in the multi-task processing model, in addition to weight coefficients, the weight layer may also include non-weight coefficients. Through research, the inventors of the present disclosure have found that non-weight coefficients in the multi-task processing model have a relatively significant impact on the accuracy of the model’s processing. Moreover, compared to weight coefficients, non-weight coefficients are relatively few within each weight layer.

Based on this, in any of the embodiments in the present disclosure, to further enhance the accuracy of the quantized multi-task processing model, the weight coefficients in each weight layer of the model have been quantized, while the non-weight coefficients in the weight layers are not quantized.

Accordingly, during the quantization process of the initial multi-task processing model, only the weight coefficients within the weight layers of the initial model are quantized, while the non-weight coefficients in each weight layer are not quantized.

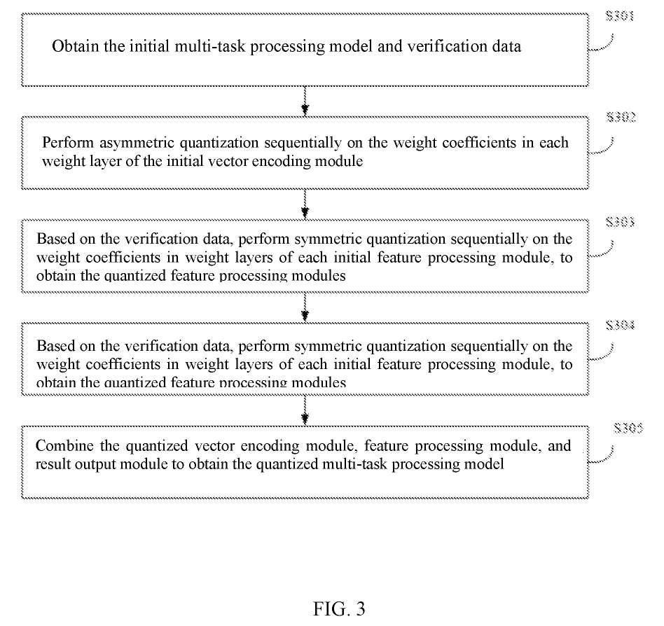

The following context describes an implementation in detail. FIG. 3 is another flowchart of the process for obtaining the quantized multi-task processing model according to an embodiment of the present disclosure. The method in this embodiment further includes:

At S301, obtaining the initial multi-task processing model and verification data.

The initial multi-task processing model includes an initial vector encoding module, an initial result output module, and at least one initial feature processing module.

At S302, performing asymmetric quantization processing sequentially on the weight coefficients in each weight layer of the initial vector encoding module.

In this case, in the initial vector encoding module, no quantization is performed on non-weight layers, and non-weight coefficients within the weight layers are also not quantized.

For example, after the model quantization module identifies each weight layer in the initial vector encoding module, when quantization is needed , it can determine the weight coefficients and non-weight coefficients (also known as outlier data) within each weight layer. This allows for isolating the non-weight coefficients in the weight layer and processing only the weight coefficients in the layer.

It is understood that, for the weight layer in any module of the initial multi-task processing model, there are no restrictions on the specific method by which the model quantization module identifies the weight coefficients within the weight layer. For example, considering that the majority of data in the weight layer consists of weight coefficients, a data distribution of all values in the weight layer can be constructed, with data points that deviate significantly from the center of this distribution being identified as non-weight coefficients.

In this case, the bit width of the integer data required for quantizing the weight coefficients in the weight layers of the initial vector encoding module can be set as needed. For example, the weight coefficients in the weight layers of the initial vector encoding module can be quantized as int4 integer data.

At S303, based on the verification data, performing symmetric quantization processing sequentially on the weight coefficients in weight layers of each initial feature processing module, to obtain the quantized feature processing modules.

The specific process of performing symmetric quantization on the weight coefficients in the weight layers of the initial feature processing module is similar to the previous description and will not be repeated here.

In this embodiment, the non-weight layers of the initial feature processing module are not quantized, and the non-weight coefficients within the weight layers of the initial feature processing module are also not quantized.

Accordingly, the feature processing module obtained through quantizing the initial feature processing module may include: the weight layers in the initial feature processing module that have been applied symmetric quantization, and the non-weight layers that are not quantized. The weight layers that have been applied symmetric quantization include, quantized weight coefficients and non-weight coefficients that have not been applied symmetric quantization.

At S304, based on the verification data, performing symmetric quantization sequentially on the weight coefficients in weight layers of the initial result output module to obtain the quantized result output module.

In this process, the non-weight layers of the initial result output module are not quantized, and the non-weight coefficients within each weight layer of the initial result output module are also not quantized.

Accordingly, the quantized result output module includes: the weight layers in the initial result output module that have been applied symmetric quantization, and the non-weight layers that are not quantized. The quantized weight layers include quantized weight coefficients and non-weight coefficients that are not quantized.

At S305, combining the quantized vector encoding module, feature processing module, and result output module to obtain the quantized multi-task processing model.

For a better understanding, an example is provided in which the multi-task processing model is derived from quantizing an initial multi-task processing model represented in 16-bit floating-point format (i.e., FP16), with the quantized weight coefficients in the multi-task processing model represented as int4 integer data.

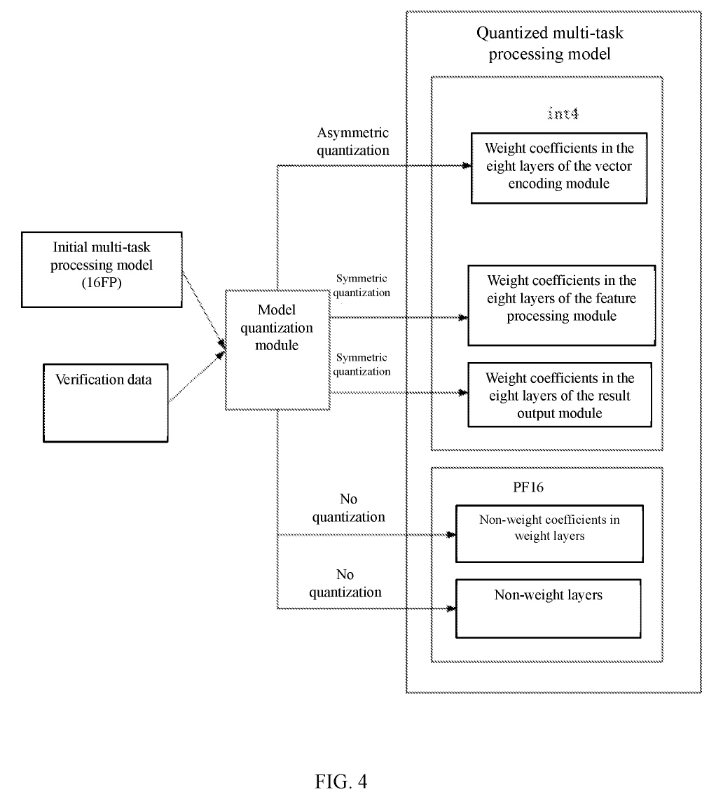

FIG. 4 is a schematic framework diagram of obtaining the quantized multi-task processing model in an embodiment of the present disclosure.

After obtaining the initial multi-task processing model represented in FP16 format, along with the verification data needed for model quantization, the model quantization module in the present disclosure can identify the initial vector encoding module, the initial result output module, and each initial feature processing module within the initial multi-task processing model.

For the weight coefficients in each weight layer of the initial vector encoding module, the method provided in the present disclosure uses an asymmetric quantization method, converting the weight coefficients represented in FP16 format into data represented in int4 format.

For the weight coefficients in the weight layers of the initial result output module and each initial feature processing module, the method provided in the present disclosure uses a symmetric quantization method, converting the weight coefficients represented in FP16 format into data represented in int4 format.

As for the non-weight layers and non-weight coefficients in the weight layers of the initial vector encoding module, initial result output module, and each initial feature processing module, these are separately isolated and not quantized.

Through the above process, the quantized and non-quantized data in the initial multi-task processing model are combined and encapsulated to obtain the quantized multi-task processing model.

It is understood that in the above embodiments of the present disclosure, after obtaining the quantized multi-task processing model and deploying it to electronic devices such as mobile phones, these devices can use the multi-task processing model to perform the task processing.

For example, the weight and non-weight layers in the multi-task processing model can be used to process the input task information. Based on the processing results from the weighted and non-weight layers of the multi-task processing model, the task response result for the task information can be determined.

It is understood that when an electronic device uses the deployed multi-task processing model for task processing, since the input data to the multi-task processing model is also floating-point data, the product of this floating-point data and the weight coefficients represented as int4 or int8 in the model is also a floating-point result. Based on this, each weight layer in the multi-task processing model still requires multiplication operations between floating-point data and integer-represented weight coefficients. Compared to integer-only multiplications, the complexity of multiplication between floating-point and integer data is higher, which results in a relatively larger computational load.

Additionally, since the processing results output by each weight layer in the multi-task processing model are also in floating-point format, a considerable amount of cache space is inevitably required.

Based on this, to further reduce the computational load and cache data size required by the electronic device when processing task information with the multi-task processing model, the electronic device in the present disclosure can deploy a model control module associated with the multi-task processing model alongside the model itself. This model control module can assist the multi-task processing model in executing control routines for task information.

Based on this, after the weight layer of the multi-task processing model outputs a processing result, the model control module can obtain this output and convert the weight layer 's processing result from floating-point data to integer data of a second bit width.

In this case, using integer data of the second bit width to represent the processing result of the weight layer requires less data than using floating-point data to represent the same result. This less data requisition decreases the storage space on the electronic device for caching the processing results of each weight layer (i.e., the intermediate processing results of the multi-task processing model).

Furthermore, after using integer data of the second bit width to presenting the processing result of a weight layer, and subsequently, when using the processing result as input data for calculations in other weight layers, the inputs for the weight layers are in integer format, and the multiplication between the integer input data and the weight coefficients, which are also represented by integer data in the weight layers, is therefore an integer-to-integer multiplication. Compared to multiplication between floating-point and integer data, or multiplication between floating-point data, operations between integer data have lower computational complexity and require fewer calculations.

Based on this, in an implementation, after obtaining the processing result of a weight layer through the model control module, the model control module determines the target weight layer, which produces the current output, in the multi-task processing model. If the model control module confirms that the next layer after the target weight layer is still a weight layer, it converts the output of the target weight layer from floating-point data to integer data of the second bit width. Accordingly, the processing result, which is based on the model control module, and represented in integer data of the second bit width, is then used as the target input information. The target input information is then input into the next layer following the target weight layer.

In the present disclosure, the second bit-width integer data may be the same as or different from the first bit-width integer data, which has been described previously. In practical applications, validation has shown that, when the first bit-width integer data is int4, setting the second bit-width integer data to int8 can preserve the processing accuracy of the multi-task processing model more effectively.

It is understood that, in order to ensure that the output data results of weight layers in the multi-task processing model remain consistent with the data range of the input information to the model, in the present disclosure, there exists de-quantization procedure of each weight layer.

The following describes an embodiment, in which the weight coefficients in the weight layers have been applied quantization, while the non-weight coefficients in the weight layers have not been quantized.

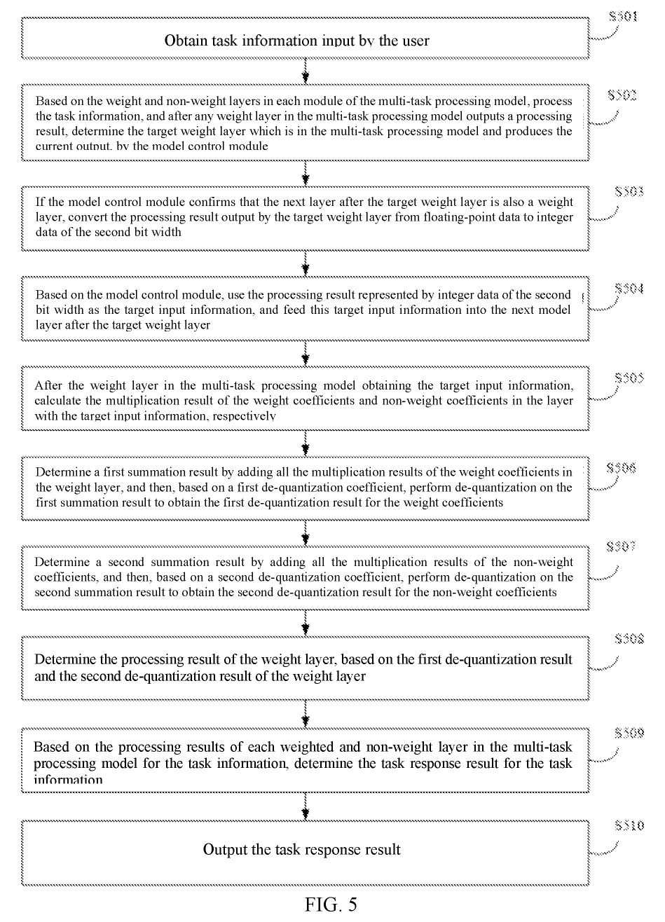

FIG. 5 is another flowchart of the information processing method according to an embodiment of the present disclosure. This method can be applied to an electronic device. The multi-task processing model and a model control module associated with the multi-task processing model are deployed in the electronic device. For example, the multi-task processing model and the model control module can be encapsulated and combined, and then deployed to the electronic device, which shall not be limited here.

This embodiment may include:

At S501, obtaining task information input by the user.

At S502, based on the weight and non-weight layers in each module of the multi-task processing model, processing the task information. After any weight layer in the multi-task processing model outputs a processing result, the method determines the target weight layer which is in the multi-task processing model and produces the current output, by the model control module.

For example, the follow content will illustrate in detail using a multi-task processing model that includes a vector encoding module, a feature processing module, and a result output module.

When the task information is input into the multi-task processing model, it first passes through the vector encoding layer within the model, where vector encoding is applied on the task information. The encoded vector is then input into the feature processing module. After processing through each feature processing module, the feature information output from the last layer of the feature processing module can be input into the result output layer, where the result output module generates the final response result.

In this process, the vector encoding module, feature processing module, and result output module may all involve the processing of information in weight layers and non-weight layers. For the processing result output from any weight layer within these modules, steps S503 to S504 are performed.

In order to help distinguishing, the weight layer in the multi-task processing model that currently has processing result to output is termed as the target weight layer.

At S503, if the model control module confirms that the next layer after the target weight layer is also a weight layer, converting the processing result output by the target weight layer from floating-point data to integer data of the second bit width.

In this case, the processing result output by the target weight layer is floating-point data. The weight coefficients in the weight layers of the multi-task processing model are quantized data.

It is understood that, if the next layer after the target weight layer is a non-weight layer, since the non-weight layer itself is not quantized, there is no de-quantization process involved. Therefore, to ensure that the non-weight layer can correctly output floating-point data, there is no need to change the data type of the information input into the non-weight layer.

For example, if the weight coefficients of each weight layer are quantized to int4 data, and the processing result output by the target weight layer is 16-bit floating-point data, then the processing result output by the target weighted layer can be converted to int8 data.

At S504, based on the model control module, using the processing result represented by integer data of the second bit width as the target input information, and feeding this target input information into the next model layer after the target weight layer.

In this case, the next model layer after the target weight layer is the layer immediately following the target weight layer in the multi-task processing model. Accordingly, the processing result output by the target weight layer needs to be fed into the next model layer

At S505, after the weight layer in the multi-task processing model obtaining the target input information, calculating the multiplication result of the weight coefficients and non-weight coefficients in the layer with the target input information, respectively.

It should be noted that, if the input to the weight layer in the multi-task processing model is the task information from the user, or the processing result output by another non-weight layer, then conventional de-quantization processing can be used directly, without using operations in steps S505 to S508.

For any weight layer in the multi-task processing model that receives target input information, which is converted into integer data of the second bit width, the de-quantization process can be performed using the operations in steps S505 to S508.

It is understood that after the target input information is input into the weighted layer, it needs to be multiplied by each weight coefficient within the layer. Since the target input information is integer data and the weight coefficients in the weighted layer are also integer data, the multiplication between the target input information and the weight coefficients is an integer-to-integer multiplication. Compared to multiplication between floating-point and integer data, this has lower computational complexity and requires fewer calculations.

It is also understood that if the non-weight coefficients in the weighted layer are not quantized, they are still represented by floating-point data, while the target input information is integer data. Therefore, the multiplication between the target input information and the non-weight coefficients is an integer-to-floating-point multiplication, which naturally requires fewer calculations than direct floating-point multiplication

At S506, determining a first summation result by adding together all the multiplication results corresponding to the weight coefficients in the weight layer. Then, based on a first de-quantization coefficient, perform de-quantization on the first summation result to obtain the first de-quantization result for the weight coefficients in the weight layer.

In this case, the first de-quantization coefficient can be set as needed.

It is understood that the multiplication of the target input information and the weight coefficients is integer-to-integer multiplication, and the resulting data range is different from the data type and range which result from multiplying the target input information by the weight coefficients before the data type conversion. To restore the original data range, it is necessary to de-quantize the multiplication results corresponding to each weight coefficient in the weight layer.

It is understood that the process of multiplying each multiplication result of the weight coefficients by the first de-quantization coefficient and then calculating the summation of the results, requires multiple multiplication operations, and results in a relatively high computational load. In this embodiment, the multiplication results of each weight coefficient in the weight layer are first added together to obtain the first summation result. Then, the first summation result is multiplied by the first de-quantization coefficient. This achieves de-quantization of all the weight coefficient products by using multiplication operation only once, which reduces the computational load.

At S507, determining a second summation result by adding together all the multiplication results corresponding to the non-weight coefficients. Then, based on a second de-quantization coefficient, perform de-quantization on the second summation result to obtain the second de-quantization result for the non-weight coefficients in the weight layer.

In this case, the second de-quantization coefficient is different from the first de-quantization coefficient.

Based on this, for the weight layer, after adding together the multiplication results corresponding to each non-weight coefficient, only once multiplication operation with the second de-quantization coefficient is needed to complete the de-quantization of all the multiplication results for the non-weight coefficients.

At S508, determining the processing result of the weight layer, based on the first de-quantization result and the second de-quantization result of the weight layer.

For example, the first de-quantization result and the second de-quantization result of the weight layer can be added together to obtain the processing result.

To assist understanding of steps S502 to S508 above, the follow content will illustrate the example while considering the case where the weight coefficients in the weight layer have been quantized to int4 data, and the non-weight coefficients in the weight layer remain in 16-bit floating-point format, and assuming that the output data result of the weight layer is in 16-bit floating-point format, and the model control module needs to convert this 16-bit floating-point data to int8 format before inputting it into the next weight layer, and then, the next weight layer performs internal calculations and de-quantization processing.

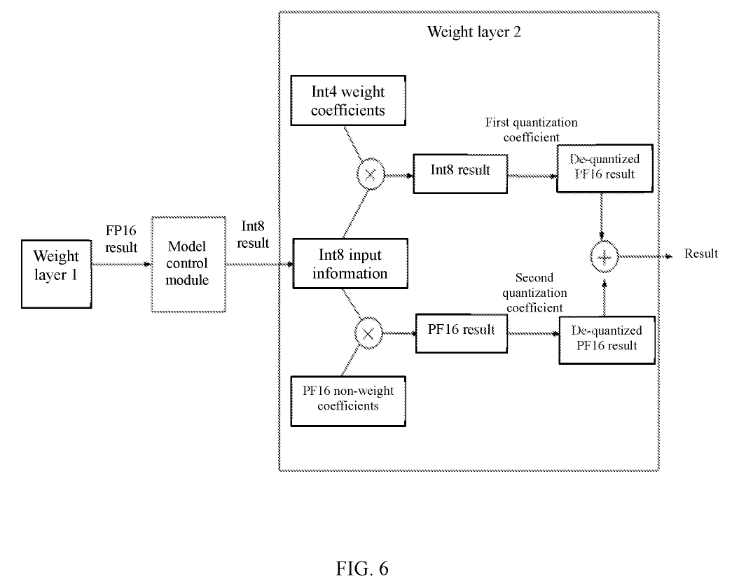

FIG. 6 is a schematic framework diagram of the de-quantization process of a weight layer under the auxiliary control of a model control module in an embodiment of the present disclosure.

In FIG. 6, two consecutive weight layers, labeled as weight layer 1 and weight layer 2, are used as an example for explanation.

As shown in FIG. 6, after weight layer 1 outputs a processing result represented in 16-bit floating-point format (i.e., FP16), the model control module converts this processing result from FP16 data to an int8 representation. The int8-represented processing result is then used as input information and fed into the next weight layer, weight layer 2

In weight layer 2, the int8 input information is multiplied by each weight coefficient represented in int4 format within weight layer 2, yielding a multiplication result for each weight coefficient. Based on this, the multiplication results for each weight coefficient are summed and then multiplied by the first de-quantization coefficient to obtain the first de-quantization result.

Additionally, in weight layer 2, the int8 input information is also multiplied by each non-weight coefficient represented in FP16 format, yielding a multiplication result for each non-weight coefficient. Based on this, the multiplication results for each non-weight coefficient are summed and then multiplied by the second de-quantization coefficient to obtain the second de-quantization result.

Based on this, both the first de-quantization result and the second de-quantization result are restored to FP16 data within the normal range.

The processing result of weight layer 2 can be achieved by adding the first de-quantization result and the second de-quantization result.

At S509, based on the processing results of each weighted and non-weight layer in the multi-task processing model for the task information, determining the task response result for the task information.

It is understood that the task response result for the task information is related to how each weighted and non-weight layer in the multi-task processing model processes the task information. The operations in steps S502 to S508 mentioned above, are all part of task information processing procedure of the multi-task processing model. Based on these steps, the multi-task processing model can ultimately output the task response result through the result output module.

At S510, outputting the task response result.

Corresponding to the information processing method, the present disclosure also provides an information processing device.

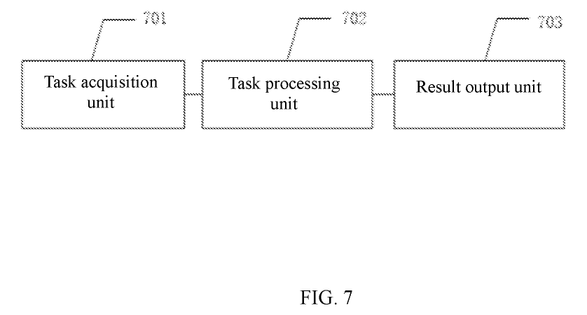

FIG. 7 is a schematic diagram of an information processing device according to an embodiment of the present disclosure. The device in this embodiment may include:

A task acquisition unit 701, configured to obtain the task information input by the user;

A task processing unit 702, configured to determine the task response result corresponding to the task information based on a multi-task processing model, wherein the multi-task processing model is one in which each weight layer has undergone quantization processing, and the quantization methods for different weight layers are not entirely the same;

A result output unit 703, configured to output the task response result.

In one possible implementation, the multi-task processing model is deployed on the electronic device.

The result output unit includes at least one of the following:

A first result output unit, configured to output the task response result to an output component within the electronic device, so that the user can receive the task response result;

A second result output unit, configured to output the task response result to a target application within the electronic device, to control the target application performing task operations according to the task response result.

In another possible implementation, the weight coefficients in the weight layers of the multi-task processing model, which is in the task processing unit, are quantized, while the non-weight coefficients in the weight layers are not quantized. Moreover, the weight coefficients in the weight layers are quantized from floating-point data to integer data of a first bit width.

In another possible implementation, the multi-task processing model includes a vector encoding module, a result output module, and at least one feature processing module, wherein the at least one feature processing module is located between the vector encoding module and the result output module.

The weight layers in the vector encoding module shall be processed with asymmetric quantization.

The weight layers in the feature processing module and the result output module shall be processed with symmetric quantization processing.

In one possible implementation, the multi-task processing model in the device is obtained through the following process:

Obtaining the initial multi-task processing model and verification data, where the initial multi-task processing model includes an initial vector encoding module, an initial result output module, and at least one initial feature processing module;

Sequentially performing asymmetric quantization processing on each weight layer in the initial vector encoding module to obtain a quantized vector encoding module;

Based on the verification data, sequentially performing symmetric quantization processing on each weight layer in each initial feature processing module to obtain quantized feature processing modules;

Based on the verification data, sequentially performing symmetric quantization processing on each weight layer in the initial result output module to obtain a quantized result output module;

Combining the quantized vector encoding module, feature processing modules, and result output module to obtain the quantized multi-task processing model.

In another possible implementation, the task processing unit includes:

A task processing subunit, configured to determine the task response result for the task information, based on the processing results of each weight and non-weight layer in the multi-task processing model;

The device provided in the present disclosure further includes:

A conversion processing unit, configured to, in the progress of the task processing subunit processing of the task information based on each weight and non-weight layer in the multi-task processing model, and after the weight layer outputs its processing result, obtain the processing result output by a weight layer through the model control module, which is associated with the multi-task processing model. This processing result from the weight layer is then converted from floating-point data to integer data of a second bit width. In this case, using integer data of the second bit width to represent the processing result from the weight layer, requires less data than using floating-point data to represent it.

In another possible implementation, the conversion processing unit includes:

A conversion subunit, configured to use the model control module to identify the target weight layer in the multi-task processing model that currently outputs the processing result. If the model control module confirms that the next layer after the target weight layer is also a weight layer, it converts the processing result output from the target weight layer from floating-point data to integer data of a second bit width;

An input subunit, configured to, based on the model control module, use the processing result represented in integer data of the second bit width as the target input information, and then input the target input information into the next layer after the target weight layer.

In another possible implementation, the task processing subunit includes:

A multiplication operation subunit, configured to, after obtaining the target input information in the weight layer of the multi-task processing model, calculate the multiplication results of the weight coefficients and non-weight coefficients in the weight layer with the target input information, respectively

A summation calculation subunit, configured to determine the first summation result from adding the multiplication results corresponding to all weight coefficients in the weight layer, and the second summation result from adding the multiplication results corresponding to all non-weight coefficients.

A first de-quantization subunit, configured to perform de-quantization on the first summation result, based on a first de-quantization coefficient, to obtain a first de-quantization result corresponding to the weight coefficients in the weight layer;

A second de-quantization subunit, configured to perform de-quantization on the second summation result, based on a second de-quantization coefficient, to obtain a second de-quantization result corresponding to the non-weight coefficients in the weight layer;

A result determination subunit, configured to determine the processing result of the weight layer based on the first and second de-quantization results of the weight layer.

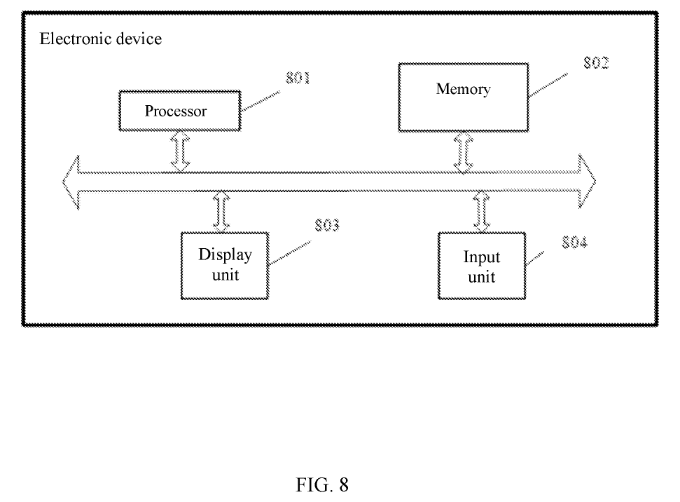

On another aspect, the present disclosure also provides an electronic device. FIG. 8 is a schematic diagram of an electronic device according to an embodiment of the present disclosure. This device can be any type of electronic device and includes at least a processor 801 and a memory 802.

The processor 801 is configured to execute the information processing method of any one of the above embodiments. The memory 802 is configured to store the programs required for the processor to perform operations.

It is understood that, the electronic device may further include a display unit 803 and an input unit 804.

Obviously, the electronic device may have more or fewer components than which are shown in FIG. 8. This aspect shall not be limited here.

On another aspect, this present disclosure also provides a computer-readable storage medium, which stores at least one instruction, at least one program segment, a code set, or an instruction set. The at least one instruction, program segment, code set, or instruction set is loaded and executed by a processor to implement the information processing method as described in any one of the above embodiments.

The present disclosure further provides a computer program. The computer program includes computer instructions stored on a computer-readable storage medium. When the computer program runs on an electronic device, it is used to execute the information processing method of any one of the above embodiments.

It is understood that, in this application, the terms 'first,' 'second,' 'third,' 'fourth,' etc., in the description, claims, and figures(if present) are used to distinguish similar elements, and are not necessarily indicative of a specific sequence or order. It should be understood that these terms can be interchanged as appropriate, so that the embodiments of this application described here can be implemented in an order other than that illustrated.

It should be noted that each embodiment in this specification is described in a progressive manner, with each embodiment primarily emphasizing aspects that differ from other embodiments. Similar or identical parts across embodiments can be referred to as needed. Additionally, the features described in each embodiment can be interchanged or combined, allowing those skilled in the art to implement or use this application. For device-related embodiments, since they are generally similar to method embodiments, the description is simplified, and relevant sections may refer to parts of the method embodiment description.

Finally, it should also be noted that in this document, relational terms such as 'first' and 'second' are only used to distinguish one entity or operation from another, and do not necessarily imply any actual relationship or sequence between these entities or operations. Furthermore, terms such as 'include,' 'comprise,' or any other variations thereof are intended to encompass non-exclusive inclusion, so that a process, method, item, or device that includes a list of elements not only includes those elements but may also include other elements not explicitly listed, or elements inherent to such a process, method, item, or device. Without further restrictions, elements defined by statements like 'includes a...' do not exclude the presence of additional identical elements in the process, method, item, or device that includes the elements

The above description of the disclosed embodiments enables those skilled in the art to implement or use this application. Different modifications to these embodiments shall be apparent to those skilled in the art, and the general principles defined herein may be implemented in other embodiments without departing from the spirit or scope of the present disclosure. Therefore, the present disclosure shall not be limited to the embodiments shown herein, but shall be accorded the broadest scope consistent with the principles and novel features disclosed.

The above are merely some embodiments of the present disclosure. It should be noted that those of ordinary skill in the art may make certain improvements and modifications without departing from the principles of this application, and these improvements and modifications should also be regarded as falling within the scope of the present disclosure.

What is claimed is:

1. An information processing method, comprising:
obtaining task information input by a user;
determining a task response result corresponding to the task information, based on a multi-task processing model; and
outputting the task response result;
wherein:
the multi-task processing model is a model with quantized weight layers; and
quantization methods corresponding to different weight layers are different.

2. The information processing method according to claim 1, wherein:
the multi-task processing model is deployed on an electronic device; and
outputting the task response result includes at least one of:
outputting the task response result to an output apparatus of the electronic device to allow the user to receive the task response result; or
outputting the task response result to a target application within the electronic device to control the target application to perform task operations according to the task response result.

3. The information processing method according to claim 1, wherein:
weight coefficients in the weight layers of the multi-task processing model are quantized, while non-weight coefficients in the weight layers are not quantized; and
the weight coefficients in the weight layers are quantized from floating-point data to integer data of a first bit-width.

4. The information processing method according to claim 1, wherein:
the multi-task processing model includes a vector encoding module, a result output module, and at least one feature processing module, and the at least one feature processing module is positioned between the vector encoding module and the result output module;
the weight layers in the vector encoding module are asymmetrically quantized; and
the weight layers in the feature processing module and the result output module are symmetrically quantized.

5. The information processing method according to claim 1, wherein determining the task response result corresponding to the task information based on the multi-task processing model includes:
determining the task response result of the task information based on processing results of the task information based on the processing results of the weight layers and non-weight layers of the multi-task processing model for the task information;
wherein:
after the weight layers of the multi-task processing model output the processing results, a model control module associated with the multi-task processing model obtains the processing result output by the weight layers to convert the processing results of the weight layers from floating-point data to integer data of a second bit-width;
using the integer data of the second bit-width to represent the processing results of the weight layers requires less data than using floating-point data to represent the processing results of the weight layers.

6. The information processing method according to claim 5, wherein obtaining the processing results output from the weight layers through the model control module associated with the multi-task processing model to convert the processing results of the weight layers from the floating-point data to the integer data of the second bit-width includes:
determining, through the model control module, a target weight layer that currently outputs a processing result in the multi-task processing model, and in response to the model control module determining that a next model layer of the target weight layer is a weight layer, converting the processing result output from the target weight layer from the floating-point data to the integer data of the second bit-width; and
based on the model control module, using the processing result represented by the integer data of the second bit-width as target input information and inputting the target input information into the next model layer of the target weight layer.

7. The information processing method according to claim 6, further comprising:
after the weight layer of the multi-task processing model receives the target input information, calculating multiplication results of the weight coefficients and non-weight coefficients in the weight layer with the target input information;
determining a first summation result by adding multiplication results corresponding to all weight coefficients in the weight layer, and a second summation result by adding multiplication results corresponding to all non-weight coefficients;
performing de-quantization on the first summation result based on a first de-quantization coefficient to obtain a first de-quantization result corresponding to the weight coefficients in the weight layer;
performing de-quantization on the second summation result based on a second de-quantization coefficient to obtain a second de-quantization result corresponding to the non-weight coefficients in the weight layer; and
determining the processing result of the weight layer based on the first de-quantization result and the second de-quantization result of the weight layer.

8. The information processing method according to claim 4, wherein generating the multi-task processing model includes:
obtaining an initial multi-task processing model and verification data, wherein the initial multi-task processing model includes an initial vector encoding module, an initial result output module, and at least one initial feature processing module;
performing asymmetric quantization processing sequentially on the weight layers in the initial vector encoding module to obtain a quantized vector encoding module;
based on the verification data, performing symmetric quantization processing sequentially on the weight layers in the initial feature processing module to obtain quantized feature processing modules;
based on the verification data, performing symmetric quantization processing sequentially on the weight layers in the initial result output module to obtain a quantized result output module; and
combining the quantized vector encoding module, feature processing modules, and result output module to obtain the quantized multi-task processing model.

9. The information processing method according to claim 8, wherein:
performing the asymmetric quantization processing sequentially on the weight layers in the initial vector encoding module includes:
performing the asymmetric quantization processing sequentially on the weight coefficients in the weight layers of the initial vector encoding module;
based on the verification data, performing the symmetric quantization processing sequentially on the weight layers in the initial feature processing module includes:
based on the verification data, performing the symmetric quantization processing sequentially on the weight coefficients in the weight layers of the initial feature processing module;
based on the verification data, performing the symmetric quantization processing sequentially on the weight layers in the initial result output module includes:
based on the verification data, performing thesymmetric quantization processing sequentially on the weight coefficients in the weight layers of the initial result output module.

10. An information processing device, comprising:
a task acquisition unit, configured to obtain task information input by a user;
a task processing unit, configured to determine a task response result corresponding to the task information based on a multi-task processing model, wherein the multi-task processing model is a model with quantized weight layers, and the quantization methods corresponding to different weight layers are different; and
a result output unit, configured to output the task response result.

11. The information processing device according to claim 10, wherein the result output unit includes at least one of:
a first result output unit, configured to output the task response result to an output apparatus of the electronic device to allow the user to receive the task response result; and;
a second result output unit, configured to input the task response result to a target application within the electronic device, to control the target application to perform task operations according to the task response result.

12. The information processing device according to claim 10, wherein:
weight coefficients in the weight layers of the multi-task processing model are quantized, while non-weight coefficients in the weight layers are not quantized; and
the weight coefficients in the weight layers are quantized from floating-point data to integer data of a first bit-width.

13. The information processing device according to claim 10, wherein:
the multi-task processing model includes a vector encoding module, a result output module, and at least one feature processing module, and the at least one feature processing module is positioned between the vector encoding module and the result output module;
the weight layers in the vector encoding module are asymmetrically quantized; and
the weight layers in the feature processing module and the result output module are symmetrically quantized.

14. The information processing device according to claim 13, wherein generating the multi-task processing model includes:
obtaining an initial multi-task processing model and verification data, wherein the initial multi-task processing model includes: an initial vector encoding module, an initial result output module, and at least one initial feature processing module;
performing asymmetric quantization processing sequentially on the weight layers in the initial vector encoding module to obtain a quantized vector encoding module;
based on the verification data, performing symmetric quantization processing sequentially on the weight layers in the initial feature processing module to obtain quantized feature processing modules;
based on the verification data, performing symmetric quantization processing sequentially on the weight layer in the initial result output module to obtain a quantized result output module; and
combining the quantized vector encoding module, feature processing modules, and result output module to obtain the quantized multi-task processing model.

15. The information processing device according to claim 10, further comprising:
a task processing subunit, configured to determine the task response result corresponding to the task information, on the processing results of the weight layers and the non-weight layers in the multi-task processing model.

16. The information processing device according to claim 10, further comprising:
a conversion processing unit, configured to, in the progress of the task processing subunit processing of the task information based on the weight layers and the non-weight layers in the multi-task processing model, and after the weight layer outputs the processing result, obtain the processing result output by a weight layer through a model control module, and then converts the processing result output from a target weight layer from floating-point data to integer data of a second bit-width.

17. The information processing device according to claim 16, wherein the conversion processing unit includes:
a conversion subunit, configured to use the model control module to identify the target weight layer in the multi-task processing model that currently outputs the processing result, in response to the model control module determining that the next layer after the target weight layer is also a weight layer, convert the processing result output from the target weight layer from floating-point data to integer data of the second bit width; and
an input subunit, configured to, based on the model control module, use the processing result represented in the integer data of the second bit width as the target input information, and then input the target input information into a next layer after the target weight layer.

18. The information processing device according to claim 15, further comprising:
a multiplication operation subunit, configured to, after the weight layer of the multi-task processing model receives the target input information, calculate multiplication results of the weight coefficients and non-weight coefficients in the weight layer with the target input information, respectively;
a summation calculation subunit, configured to determine a first summation result by adding multiplication results corresponding to all weight coefficients in the weight layer, and a second summation result by adding the multiplication results corresponding to all non-weight coefficients;
a first de-quantization subunit, configured to perform de-quantization on the first summation result based on a first de-quantization coefficient to obtain a first de-quantization result corresponding to the weight coefficients in the weight layer;
a second de-quantization subunit, configured to perform de-quantization on the second summation result based on a second de-quantization coefficient to obtain a second de-quantization result corresponding to the non-weight coefficients in the weight layer; and
a result determination subunit, configured to determine the processing result of the weight layer based on the first de-quantization result and the second de-quantization result of the weight layer.

19. An electronic device, comprising:
one or more processors;
one or more memories storing a program that, when executed by the one or more processors, causes the one or more processors to:
obtain task information input by a user;
determine a task response result corresponding to the task information, based on a multi-task processing model; and
output the task response result;
wherein:
the multi-task processing model is a model with quantized weight layers; and
quantization methods corresponding to different weight layers are different.

20. The electronic device according to claim 19, wherein:
the multi-task processing model is deployed on an electronic device; and
the one or more processors are further configured to perform at least one of:
output the task response result to an output apparatus of the electronic device to allow the user to receive the task response result; or
output the task response result to a target application within the electronic device to control the target application to perform task operations according to the task response result.
